(19) United States
(12) Patent Application Publication
(10) Pub. No.: US 2006/0203826 A1
(43) Pub. Date: Sep. 14, 2006

(54) Method for ensuring QoS for isochronous data in residential ethernet system including legacy ethernet device

(75) Inventors: Jae-Hun Cho, Seoul (KR); Jong-Ho Yoon, Goyang-si (KR); Sang-Ho Kim, Hwaseong-si (KR); Sihai Wang, Suwon-si (KR); Yun-Je Oh, Yongin-si (KR); Jun-Ho Koh, Suwon-si (KR)

Correspondence Address: CHA & REITER, LLC, 210 ROUTE 4 EAST STE 103, PARAMUS, NJ, 07652, US

(73) Assignee: Samsung Electronics Co., LTD.

(21) Appl. No.: 11/372,951

(22) Filed: Mar. 10, 2006

(30) Foreign Application Priority Data
Mar. 14, 2005 (KR) 2005-21188
Mar. 16, 2005 (KR) 2005-21798

(51) Int. Cl. H04L 12/28; H04L 12/56

(52) U.S. Cl. 370/395.53

(57) ABSTRACT

Disclosed is a method, apparatus and computer product for ensuring QoS (Quality of Service) of isochronous data in a Residential Ethernet system including a legacy Ethernet device and a first Residential Ethernet switch, in which the first Residential Ethernet switch transmits data packets to the legacy Ethernet device, the method comprising the steps of inserting, by the first Residential Ethernet switch, virtual local area network (VLAN) tags into the data packets in order to allocate priorities to the data packets, and establishing priorities of the VLAN tags such that a highest priority is allocated to isochronous packets from among the data packets.

### CLAIM OF PRIORITY

This application claims the benefit under 35 U.S.C. 119 to those patent applications entitled “Method For Ensuring QoS For Isochronous Data In Residential Ethernet System Including Legacy Ethernet Device,” filed in the Korean Intellectual Property Office on Mar. 14 and 16, 2005 and assigned Serial Nos. 2005-21188 and 2005-21798, respectively, the entire contents of which are incorporated herein by reference.

### BACKGROUND OF THE INVENTION

1. Field of the Invention

The present invention relates to Residential Ethernet, and more particularly to a method for ensuring QoS (Quality of Service) of isochronous data in a Residential Ethernet system including a Legacy Ethernet device.

2. Description of the Related Art

Ethernet is the most widely used local area network (LAN) technology and is now defined by the Institute of Electrical and Electronics Engineers (IEEE) 802.3 standard. Ethernet has been originally developed by Xerox Corporation and has been advanced by Xerox Corporation, Digital Equipment Corporation (DEC), Intel Corporation, among other companies. Ethernet is a technology generally used when data are transmitted among a plurality of terminals or users.

In conventional Ethernet, as competitive access is accomplished by means of a carrier sense multiple access/collision detect (CSMA/CD) protocol stipulated in the IEEE 802.3 standard, a service frame of an upper layer is converted to an Ethernet frame while maintaining an inter frame gap (IFG), and the Ethernet frame is transmitted. In this case, upper service frames are transmitted according to the sequence of their generation, regardless of the kind of generation. However, Ethernet has been known to be insufficient for transmitting a moving image (video) and voice data susceptible to transmission delay, as Ethernet employs the CSMA/CD scheme in which every Ethernet frame is allocated with an equal priority and is competitively transmitted.

However, as the transmission of moving images and voice data has increased, their relative importance in data transmission has become greater various methods have been proposed for removing problems caused by transmission delay in using the Ethernet scheme. One representative scheme for removing the problem caused by transmission delay is a Residential Ethernet scheme. According to the Residential Ethernet scheme, isochronous data and asynchronous data are separately transmitted during one cycle while an upper priority is allocated to the isochronous data in transmission, thereby ensuring QoS for a service such as transmitting as isochronous data a moving image susceptible to a transmission delay.

However, a detailed method for processing isochronous data in a system, in which the Residential Ethernet is associated with a conventional legacy Ethernet device, has not yet been proposed.

FIG. 1 is a block diagram illustrating the construction of a system in which Residential Ethernet devices and existing legacy Ethernet devices are connected.

The Residential Ethernet devices 100 and the conventional legacy Ethernet devices 108, 109, 110, and 120 are separately constructed, and only asynchronous data can be transmitted between the Residential Ethernet devices 100 and the legacy Ethernet devices 108 and 109.

In detail, the Residential Ethernet devices 100 include devices 101 to 107 supporting Residential Ethernet, which form a “cloud” 100. Isochronous data can be transmitted/received only between the devices 101 to 107. The end devices 110, 111, 113, 104, 105, 106, 107, 121 and 122 are connected to the corresponding switch or hub.

Meanwhile, the Ethernet switch 108 and the Ethernet hub 109, which are conventional legacy Ethernet devices, are connected to Residential Ethernet switch 101 included in the Residential Ethernet cloud 100, to transmit/receive asynchronous packets in sections 110 and 120, where Residential Ethernet is not supported (i.e. where an isochronous packet transmission is not supported).

Hence, as shown in FIG. 1, when conventional Residential Ethernet is realized, the legacy Ethernet devices cannot be located in the middle of the entire Residential Ethernet topology. The problem of including a legacy Ethernet device within a Residential Ethernet topology is described with reference to FIG. 2.

FIG. 2 is a block diagram describing data processing when a conventional legacy Ethernet device is located among Residential Ethernet devices.

When a conventional legacy switch 21 is located among Residential Ethernet devices 22, 23, and 24, data are transmitted as follows:

First, a first Residential Ethernet switch 22 receives isochronous packets 201 and 202 in a predetermined interval 200 (e.g. 125 μsec) from an isochronous peer device 25, and receives an asynchronous packet 203 from a first asynchronous peer device 26 and a second asynchronous packet 204 received from device 27. The block 28 indicates the end devices connected to the ResE device 24.

The isochronous packets 201 and 202 and asynchronous packet 203, input to the first Residential Ethernet switch 22 are output from the first Residential Ethernet switch 22, while the predetermined interval 200 is maintained between the isochronous packets 201 and 202 according to the property of Residential Ethernet.

When the legacy switch 21 receives the isochronous packets 201 and 202 and asynchronous packet 203, output from the first Residential Ethernet switch 22, the legacy switch 21 outputs the received packets 201, 202, and 203 according to their input order, without taking into consideration the interval 200 between the isochronous packets 201 and 202.

Accordingly, the legacy switch 21 outputs input packets in the order of the first isochronous packet 201, the first asynchronous packet 203, a second asynchronous packet 204, and the second isochronous packet 202, wherein the interval between the isochronous packets 201 and 202 becomes longer than the predetermined interval 200, as indicated by reference numeral 200′.

This increase or variation in the isochronous packet gap makes the Residential Ethernet system unable to maintain a predetermined interval between isochronous packets 201, 202, which is required for providing a specific QoS level. Thus, it becomes impossible to maintain the advantages of the Residential Ethernet system when transmitting isochronous packets. Therefore, the legacy Ethernet device is restricted from being located in the middle of the entire Residential Ethernet topology.

However, such restriction may greatly limit the expansion of Residential Ethernet in view of compatibility with conventional devices, and is thus expected to rise a serious problem.

With the development of communication technology, information communication is being developed in a form of combining data, voice, and images (video). That is, it is expected that the boundaries among a broadcasting industry, a communication industry, and an image industry will disappear as these industries develop into a combined form. Under such an environment, if Residential Ethernet must be deployed without utilizing legacy Ethernet devices for broadcasting, communication, and image transmission, it would be difficult to simplify system expansion, as well as the economics of such system construction.

### SUMMARY OF THE INVENTION

Accordingly, the present invention has been made to solve the above-mentioned problems occurring in the prior art and provides additional advantages, by providing a method for ensuring QoS (Quality of Service) of isochronous data in a Residential Ethernet system including existing legacy Ethernet devices, so as to ensure downlink-compatibility with the legacy Ethernet devices in a Residential Ethernet system for transmitting an isochronous packet.

In accordance with one aspect of the present invention, there is provided a method for ensuring QoS (Quality of Service) of isochronous data in a Residential Ethernet system including legacy Ethernet devices, and a first Residential Ethernet switch, in which the first Residential Ethernet switch transmits data packets to the legacy Ethernet device, the method comprising the steps of inserting, by the first Residential Ethernet switch, virtual local area network (VLAN) tags into the data packets in order to allocate priorities to the data packets and establishing priorities of the VLAN tags such that a highest priority is allocated to an isochronous packet from among the data packets.

Preferably, the method further comprises a step of lowering a priority of an asynchronous packet having a high priority to a next lower level, when the asynchronous packet having the high priority is input to the legacy Ethernet device.

### BRIEF DESCRIPTION OF THE DRAWINGS

The above features and advantages of the present invention will be more apparent from the following detailed description taken in conjunction with the accompanying drawings, in which:

FIG. 1 is a block diagram illustrating the construction of a system in which Residential Ethernet devices and existing legacy Ethernet devices are connected;

FIG. 2 is a block diagram illustrating data processing when a conventional legacy Ethernet device is located among Residential Ethernet devices;

FIG. 3 is a view describing a virtual local area network (VLAN) tag in connection between Residential Ethernet switches and a Legacy switch according to an embodiment of the present invention;

FIG. 4 is a view describing the insertion of a VLAN tag which is applied to the present invention;

FIG. 5 is a block diagram illustrating the construction of a Residential Ethernet switch for processing data received from a legacy Ethernet device according to an embodiment of the present invention;

FIG. 6 is a flowchart illustrating the operation of the Residential Ethernet switch for processing data received from a legacy Ethernet device according to an embodiment of the present invention;

FIG. 7 is a block diagram describing the environment in which a first Legacy Ethernet device receives asynchronous data having the highest priority from a second Legacy Ethernet device, while receiving isochronous data having the highest priority allocated according to the present invention;

FIG. 8 is a block diagram describing a priority allocation method for isochronous packets under an environment as described with reference to FIG. 7; and

FIGS. 9A to 9C are views illustrating the structure of a VLAN tag for allocating a new priority according to an embodiment of the present invention.

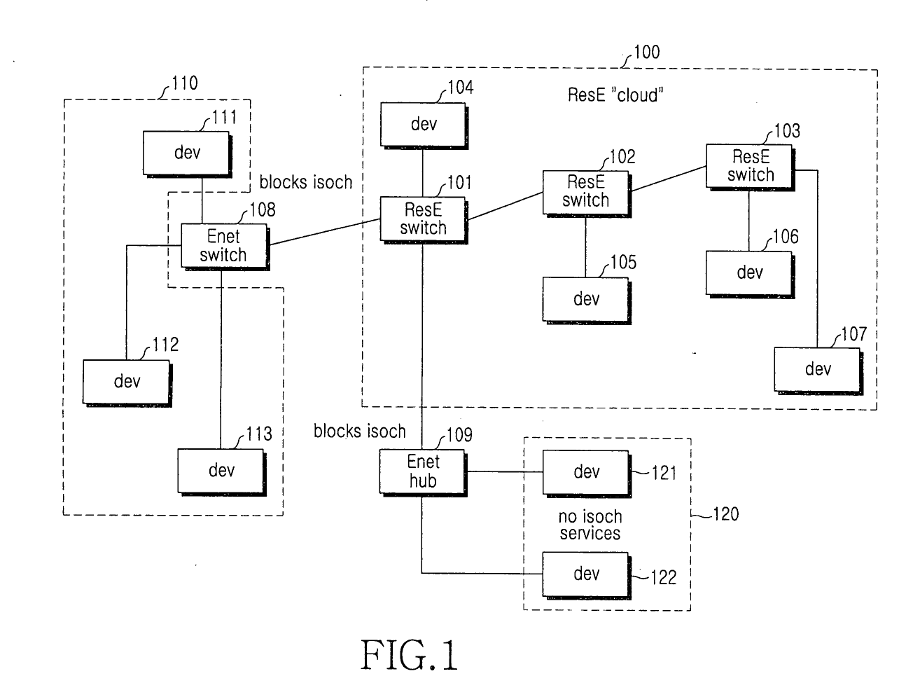

### DETAILED DESCRIPTION

Hereinafter, embodiments of the present invention will be described with reference to the accompanying drawings. It is to be noted that the same elements are indicated with the same reference numerals throughout the drawings. For the purposes of clarity and simplicity, a detailed description of known functions and configurations incorporated herein will be omitted when it may obscure the subject matter of the present invention.

The present invention provides a method of connecting a legacy Ethernet device to Residential Ethernet devices in a Residential Ethernet system such that the legacy Ethernet device can process data as the Residential Ethernet devices. To this end, according to the present invention, when a legacy Ethernet device supporting an IEEE (Institute of Electrical and Electronics Engineers) 802.1p/Q protocol for performing priority allocation in transmission of a data packet is located in the middle of a Residential Ethernet topology, the legacy Ethernet device is connected and constructed such that isochronous data are allocated with the highest priority and are processed based on the allocated priority.

Although the following description presents the IEEE 802.1p/Q protocol as an example of protocol for performing priory allocation, it will be understood by those skilled in the art that a different protocol, such as an IEEE 802.1e protocol, having the same function as that of the IEEE 802.1p/Q protocol can be used within the scope of the present invention.

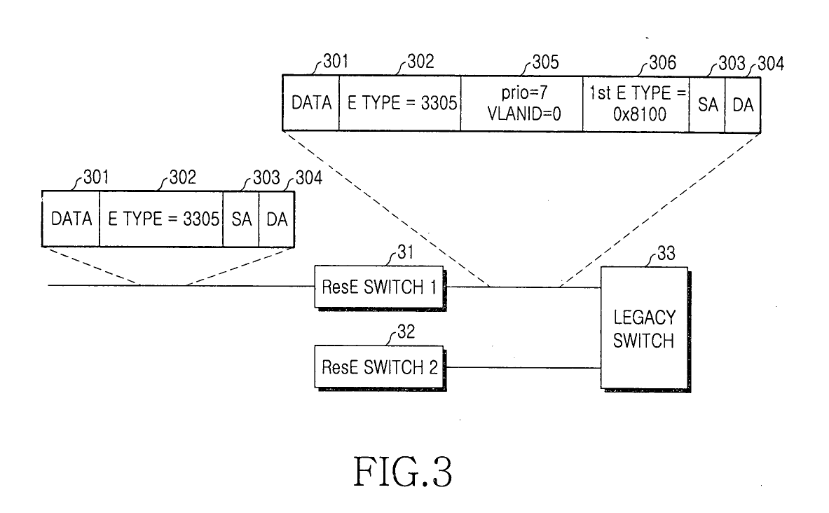

FIG. 3 is a view describing a virtual local area network (VLAN) tag in connection between Residential Ethernet switches and a legacy switch according to an embodiment of the present invention.

In a topology in which a first Residential Ethernet switch 31 is connected to a legacy switch 33, and the legacy switch 33 is connected to a second Residential Ethernet switch 32, Residential Ethernet data input to the first Residential Ethernet switch 31 include a destination address (DA) field 304 representing a destination address, a source address (SA) field 303 representing a source address, an E-type field 302 representing an Ethernet type of data to be transmitted, and a data field 301 containing data to be transmitted.

Herein, it is assumed that the E-type filed 302 has a value of “3305” when a transmitted data is an isochronous packet. Although the value “3305” is used in the example herein, it would be recognized that the invention is not limited to this specific value and other values may be used without limiting the scope of the invention claimed.

Such an isochronous packet input to the first Residential Ethernet switch 31 is allocated with a priority by using VLAN tags 305 and 306, in order to be transmitted from the first Residential Ethernet switch 31 to the legacy switch 33.

That is, a tag control information (TCI) field 305 representing a priority and a virtual local area network identifier (VLAN ID) and a tag protocol identifier (TPID) field 306 representing tag protocol information are additionally inserted into an isochronous packet, which includes the destination address (DA) field 304 representing a destination address, the source address (SA) field 303 representing a source address, the E-type field 302 representing an Ethernet type of data to be transmitted, and the data field 301 containing data to be transmitted, before the isochronous packet is transmitted from the first Residential Ethernet switch 31 to the legacy switch 33.

In this embodiment of the present invention, the TPID field 306 is represented by a first E type, and the first E type having a value of “8100” refers to a predetermined packet into which a VLAN tag is inserted. Although the value “8100” is used in the example herein, it would be recognized that the invention is not limited to this specific value and other values may be used without limiting the scope of the invention claimed.

Such a VLAN tag is additionally inserted into an existing Ethernet packet.

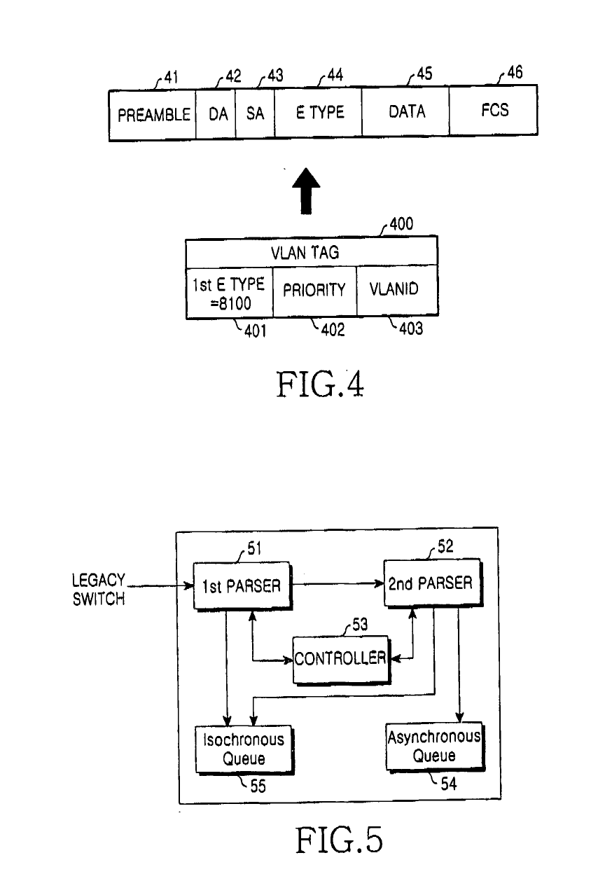

FIG. 4 is a view describing the insertion of a VLAN tag to the data stream in accordance with the principles of the present invention.

A typical Ethernet packet includes a preamble field 41 which is header information including a message number, a receiver number, etc., a destination field (DA) 42 representing a destination address, a source address (SA) field 43 representing a source address, an E-type field 44 representing an Ethernet type of data to be transmitted, a data field 45 containing data to be transmitted, and a frame check sequence (FCS) field 46 for detecting a frame transmission error.

A VLAN tag 400 includes tag control information (TCI) fields 402 and 403 representing a priority and a virtual local area network identifier (VLAN ID), and a tag protocol identifier (TPID) field 401 representing tag protocol information.

In another embodiment of the present invention, the TPID field 401 is represented by a second E type, and the second E type having a value of “8100” refers to a predetermined packet into which a VLAN tag is inserted. The term “second E type” is used, only because the VLAN tag is inserted into a back portion of the existing E-type field 44, so that a receiver detects and processes the second E type information posterior to an existing E type information when obtaining E type information through a first parsing. That is, the term “second E type” is for illustrative purposes only, and the scope of the invention is not limited thereto. Note that in the description, TPID field will be represented by a second E type, and a typical Ethernet type will be represented by a first E type.

A priority field 402 represents priority information for the encoding of a frame, and has one of eight levels of priorities based on the IEEE 802.1p/Q protocol.

A VLAN ID field 403 is used to present a unique ID for a frame, and includes a maximum of “2¹²−1” IDs. The embodiment of the present invention employs “zero” as a value of the VLAN ID field 403 in order to represent that a VLAN ID does not exist.

In order to ensure QoS of isochronous data in a Residential Ethernet topology including a legacy Ethernet device (e.g. legacy switch), each packet is constructed having a structure including a tag in the IEEE 802.1p/Q protocol, as shown in FIGS. 3 and 4, so that a unique E type is presented to represent that a packet is an isochronous packet of Residential Ethernet, and the highest priority is allocated based on the IEEE 802.1p/Q.

As a result, the second Residential Ethernet switch 32 receives data according to a priority from the legacy switch 33 in the topology shown in FIG. 3, and processes the received data. The second Residential Ethernet switch 32 for performing such a function may be constructed as shown in FIG. 5.

FIG. 5 is a block diagram illustrating the construction of a Residential Ethernet switch for processing data received from a legacy Ethernet device according to an embodiment of the present invention.

A Residential Ethernet switch includes a first parser 51, a second parser 52, an asynchronous queue 54 for processing asynchronous packets, an isochronous queue 55 for processing isochronous packets, and a controller 53 connected to each of the units 51, 52, 54, and 55 so as to control the units. The first parser 51 performs a first parsing operation with respect to a data packet received from the legacy switch 33 so as to extract first E type information, transfers the extracted first E type information to the controller 53, and outputs the received data packet according to the control of the controller 53 based on the first E type information. The second parser 52 performs a second parsing operation with respect to a data packet received from the first parser 51 so as to extract second E type information, transfers the extracted second E type information to the controller 53, and outputs the received data packet according to the control of the controller 53 based on the second E type information.

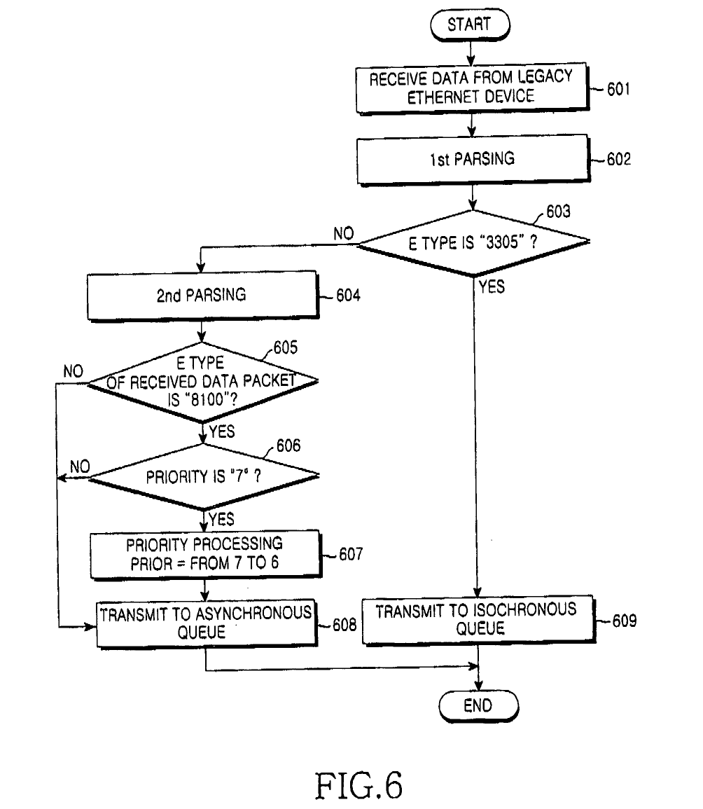

The operation of the Residential Ethernet switch having the construction as shown in FIG. 5 will now be described in detail with reference to FIG. 6.

FIG. 6 is a flowchart illustrating the operation of the Residential Ethernet switch for processing data, which have been received from a legacy Ethernet device according to an embodiment of the present invention.

In order to process data, which have been transmitted from a legacy Ethernet device, first, the Residential Ethernet switch receives data from the legacy Ethernet device (e.g. legacy switch) in step 601.

The Residential Ethernet switch performs a first parsing operation with respect to the received data at step 602, and determines if the first E type of a received data packet has a predetermined value of (e.g., “3305”) at step 603. The value of “3305” is for illustrative purposes only, and a different value can be used to determine if the received data packet is an isochronous packet. The first parsing operation is performed by the first parser 51 shown in FIG. 5.

When it is determined, as a result of step 603, that the received data packet is an isochronous packet, the received data is transmitted to the isochronous queue 55 to be processed as isochronous data at step 609.

However, when it is determined, as a result of step 603, that the received data packet is an asynochronous packet, the received data packet is transmitted to the second parser 52 to be subjected to a second parsing operation at step 604. Then, it is determined if E type information obtained through the second parsing operation has a predetermined value (e.g.,“8100”) (step 605). The value of “8100” is for illustrative purposes only, and a different value may be used to represent the received data includes a VLAN tag packet. The second parsing operation is performed by the second parser 52 shown in FIG. 5.

When it is determined, as a result of step 605, that the received data packet does not include a VLAN tag, the received data packet is determined to be a typical Ethernet packet and is transmitted to the asynchronous queue 54 to be processed as asynchronous data at step 608

When it is determined, as a result of step 605, that the received data packet includes a VLAN tag, the received data packet determines if the priority of the corresponding packet is the highest “7” at step 606. If the priority is not the highest, the received data packet is determined to be a typical Ethernet packet and is transmitted to the asynchronous queue 54 to be processed as asynchronous data at step 608.

When it is determined, as a result of step 606, that the received data packet has a highest priority (7), a priority of the data packet is lowered to a next higher priority (6), and is transmitted to the asynchronous queue 54 to be processed as asynchronous data at step 608.

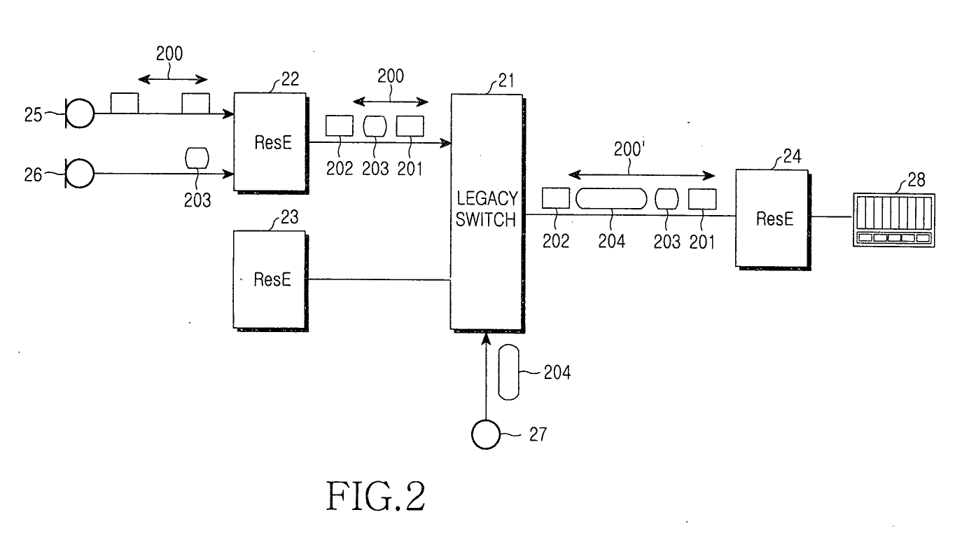

The present invention provides a method of allocating the highest priority to an isochronous packet through the operation described with reference to FIGS. 2 to 6. However, a legacy Ethernet device (e.g. legacy switch) performing the above-mentioned operation may receive asynchronous data having a high priority from a different legacy Ethernet device, and thus the transmission of an isochronous packet may be obstructed. Hereinafter, a method for processing the priority of an asynchronous packet that may collide with the priority of an isochronous packet in the legacy Ethernet device will be described.

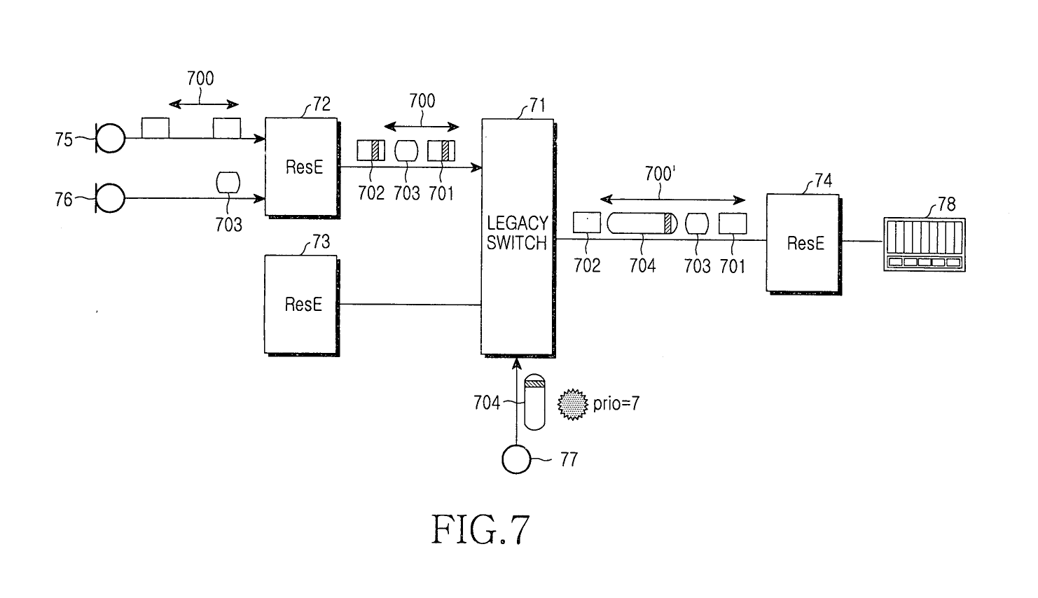

FIG. 7 is a block diagram describing the environment in which a first legacy Ethernet device receives asynchronous data having a high priority from a second legacy Ethernet device, while receiving isochronous data having a high priority allocated according to the present invention.

When a legacy switch 71 is located among Residential Ethernet devices 72, 73, and 74, data are transmitted as follows:

First, a first Residential Ethernet switch 72 receives isochronous packets 701 and 702 in a predetermined interval 700 (e.g. 125 μsec) from an isochronous peer device 75, and receives an asynchronous packet 703 from a first asynchronous peer device 76. The block 78 represents the end devices connected to the ResE device 74.

The isochronous packets 701 and 702 and asynchronous packet 703, having been input to the first Residential Ethernet switch 72, are output from the first Residential Ethernet switch 72, while the predetermined interval 700 is maintained between the isochronous packets 701 and 702 according to the property of Residential Ethernet. In this case, according to an embodiment of the present invention, the isochronous packets 701 and 702 are allocated with the highest priority by using a VLAN tag.

When the legacy switch 71 receives the isochronous packets 701 and 702 and asynchronous packet 703, having been output from the first Residential Ethernet switch 72, the legacy switch 71 outputs the received packets 701, 702, and 703 according to their priorities.

In addition, when the legacy switch 71 receives an asynchronous packet 704 from a different legacy Ethernet device 77 connected to the legacy switch 71, if the received asynchronous data packet 704 has a lower priority, the interval 700 between the isochronous packets 701 and 702 can be maintained. This is because the isochronous packets 701 and 702 having the higher priority are processed before data packets having a lower priority.

However, if the asynchronous packet 704 having a higher priority is input from the different legacy Ethernet device 77 to the legacy switch 71, the predetermined interval 700 between the isochronous packets 701 and 702 cannot be maintained, and a new interval 700′ is created between the isochronous packets 701 and 702, as shown in FIG. 7. This causes a problem in that QoS of isochronous data cannot be ensured.

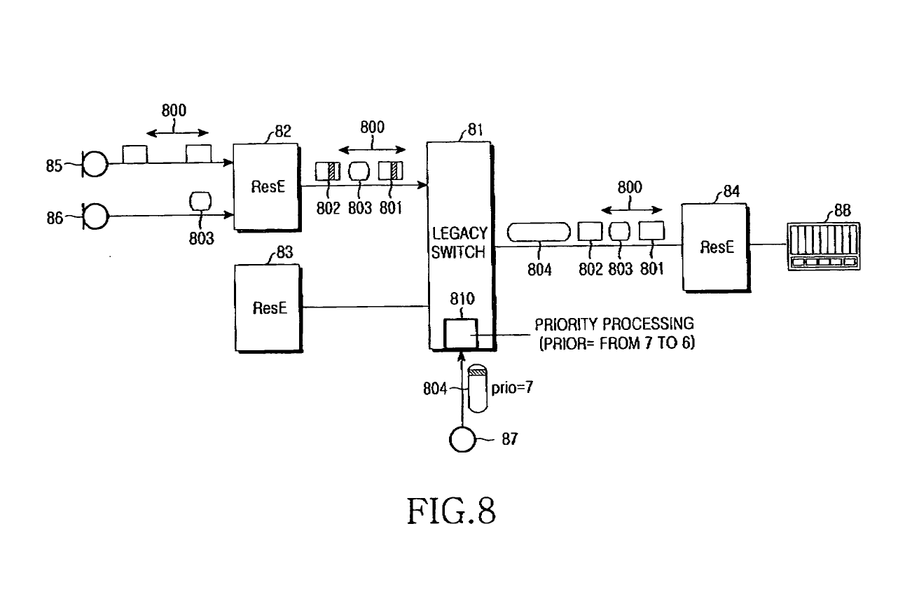

FIG. 8 is a block diagram describing a priority allocation method for isochronous packets under such an environment as described with reference to FIG. 7.

When legacy switch 81 is located among Residential Ethernet devices 82, 83, and 84, data are transmitted as follows:

A first Residential Ethernet switch 82 receives isochronous packets 801 and 802 in a predetermined interval 800 (e.g. 125 μsec) from an isochronous peer device 85, and receives an asynchronous packet 803 from a first asynchronous peer device 86. The block 88 indicates end devices connected to the ResE device 84.

The isochronous packets 801 and 802 and asynchronous packet 803, input to the first Residential Ethernet switch 82, are output from the first Residential Ethernet switch 82, while the predetermined interval 800 is maintained between the isochronous packets 801 and 802 according to the property of Residential Ethernet. In this case, according to an embodiment of the present invention, the isochronous packets 801 and 802 are allocated with the highest priority by using a VLAN tag.

When the legacy switch 81 receives the isochronous packets 801 and 802 and asynchronous packet 803, output from the first Residential Ethernet switch 82, the legacy switch 81 outputs the received packets 801, 802, and 803 according to their priorities.

In this case, if an asynchronous packet 804 having a high priority is input from a different legacy Ethernet device 87 to the legacy switch 81, the input asynchronous packet 804 collides with the isochronous packets 801 and 802 because they have same priority. This causes a problem in that QoS of isochronous data cannot be maintained.

Therefore, according to an embodiment of the present invention, when the different legacy Ethernet device 87 is connected to a specific port of a legacy Ethernet device (e.g. legacy switch), a priority re-creation function of the legacy switch 81 is performed with respect to packets having the high priority, so that the packets may be allocated with a priority which is one-level lower than their original priority. Accordingly, any packet input from a different legacy Ethernet device to the legacy switch 81 cannot have a higher priority, so that only a packet having highest priority is input to the legacy switch 81 from only a Residential Ethernet switch. A legacy Ethernet device may recover the original priority of a packet, which was lowered by one level through the priority re-creation function, before outputting the packet, so that change of priority may be restricted to the operation of the relevant legacy Ethernet device.

Meanwhile, an asynchronous packet transmitted from a Residential Ethernet switch to a legacy Ethernet device may also have the highest priority. In this case, since such an asynchronous packet having the highest priority may collide with an isochronous packet transmitted from another Residential Ethernet switch in the legacy Ethernet device, it is necessary to prevent such collision. However, in this case, since the asynchronous packet having the highest priority is input through the same port as the isochronous packet, it is impossible to apply the method using a port of a relevant legacy Ethernet device, as described with reference FIG. 8, to the asynchronous packet.

In this case, it is necessary to control the Residential Ethernet switch in such a manner that the Residential Ethernet switch does not allocate the highest priority to an asynchronous packet when outputting the asynchronous packet. That is, although there is an asynchronous packet which may be allocated with the highest priority based on the IEEE 802.1p/Q standard, the Residential Ethernet switch forcibly allocates the lower priority to the asynchronous packet when outputting the asynchronous packet, thereby preventing collision between the asynchronous packet and an isochronous packet in a legacy Ethernet device.

Meanwhile, a legacy Ethernet device may allocate an isochronous packet with a new priority of a higher level than the existing priority, so that the legacy Ethernet device may process the isochronous packet first, without changing the priority of an asynchronous packet input to the legacy Ethernet device.

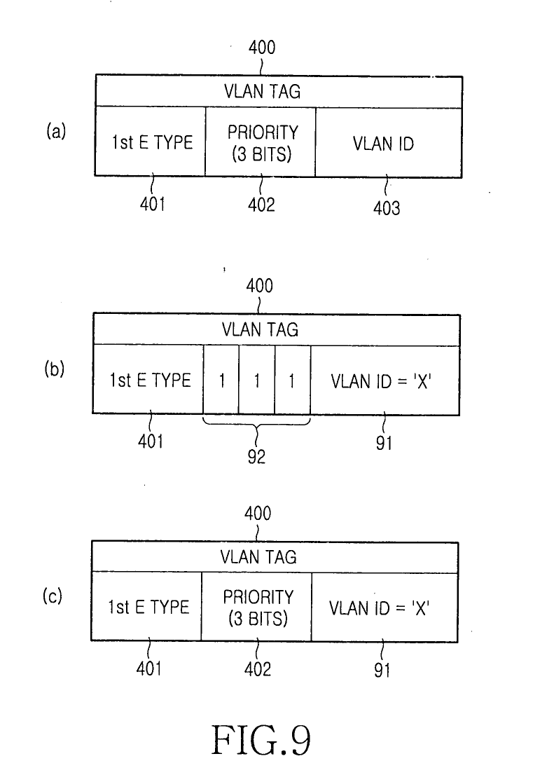

FIGS. 9A to 9C are views illustrating the structure of a VLAN tag for allocating a new priority according to an embodiment of the present invention.

FIG. 9A is a view illustrating the structure of a VLAN tag employed in the present invention.

A VLAN tag 400 includes tag control information (TCI) fields 402 and 403 representing a priority and a virtual local area network identifier (VLAN ID), and a tag protocol identifier (TPID) field 401 representing tag protocol information.

In this embodiment of the present invention, the TPID field 401 is represented by a first E type, and the first E type having a value of “8100” refers to a predetermined packet into which a VLAN tag is inserted. The term “first E type” is used, only because the VLAN tag is inserted into a front portion of the existing E-type field 44 (FIG. 4), so that a receiver detects and processes the first E type information prior to an existing E type information when obtaining E type information through a first parsing. That is, the term “first E type” is for illustrative purposes only, and the scope of the invention is not limited thereto.

A priority field 402 represents priority information for encoding of a frame, and has one of eight levels based on the IEEE 802.1p/Q protocol.

A VLAN ID field 403 is used to present a unique ID for a frame, and includes a maximum of “2¹²−1” IDs. The embodiment of the present invention employs “zero” as a value of the VLAN ID field 403 in order to represent that a VLAN ID does not exist.

The present invention proposes that a VLAN ID field is used to allocate an isochronous packet with a new priority higher than any other existing priority.

According to a first embodiment of the present invention, as shown in FIG. 9B, when the value of an existing priority filed 402 is established as “111” 92 representing the highest priority, and a VLAN ID field has a value of “X” 91 representing that a relevant packet is an isochronous packet, the relevant packet is established to have a new priority higher than any other priority which can be expressed by the existing VLAN tag.

That is, when the priority field has a value representing the highest priority, and the VLAN ID field has a specific VLAN ID value, a new priority is allocated to the relevant packet. Presently, since the value of the VLAN ID field may be selected from “2¹²−1” values, it is possible to establish a new value for processing an isochronous packet, from among the “2¹²−1” values.

According to a second embodiment of the present invention, as shown in FIG. 9C, when the VLAN ID field has a specific value “X” 91 representing that a relevant packet is an isochronous packet, regardless of the value of the existing priority field 402, the relevant packet is established to have a new priority higher than any other priority which can be expressed by the existing VLAN tag.

That is, when a packet has a specific VLAN ID value, regardless of the value of the priority field, a new priority is allocated to the packet. Presently, since the value of the VLAN ID field may be selected from “2¹²−1” values, it is possible to establish a new value for processing an isochronous packet from among the “2¹²−1” values.

According to still another embodiment of the present invention, the area for the priority field of a VLAN tag is expanded so that the value of the priority field can be expressed by 4 or more bits, thereby enabling a new priority to be allocated to an isochronous packet.

Although FIGS. 9B and 9C specify a VLAN ID value in order to allocate a new priority, the VLAN ID value may be not specified. That is, it is possible to allocate a new priority by assigning a predetermined field (e.g. Residential flag field) for establishing the priority of an isochronous packet, and then activating/non-activating the value of the predetermined field. That is, when the value of the Residential flag field is activated, and the priority field of the existing VLAN tag has a value of “111”, a priority higher than any other priority, which can be expressed in the existing VLAN tag, is established for the relevant packet. In addition, when the value of the Residential flag field is activated, a priority higher than any other priority, which can be expressed in the existing VLAN tag, is established for the relevant packet, regardless of the value of the priority field in the existing VLAN tag.

The method according to the present invention can be realized by a program and can be stored on a recording medium (such as a CD ROM, a RAM, a floppy disk, a hard disk, a magneto-optical disk, etc.) or downloaded over a network in a format that can be read by a computer.

According to the present invention as described above, the Residential Ethernet can be achieved such that the Residential Ethernet has downlink-compatibility in a topology including an existing legacy Ethernet device using either 802.1p/Q or 802.11e protocol standards.

In addition, the present invention uses the existing devices while ensuring QoS for the Residential Ethernet, thereby strengthening competitiveness of the Residential Ethernet.

While the present invention has been shown and described with reference to certain preferred embodiments thereof, it will be understood by those skilled in the art that various changes in form and details may be made therein without departing from the spirit and scope of the invention as defined by the appended claims. Accordingly, the scope of the invention is not to be limited by the above embodiments but by the claims and the equivalents thereof.

What is claimed is:

1. A method for ensuring QoS (Quality of Service) of isochronous data in a Residential Ethernet system including a legacy Ethernet device, a first Residential Ethernet switch, in which the first Residential Ethernet switch transmits data packets to the legacy Ethernet device, the method comprising the steps of:
inserting, by the first Residential Ethernet switch, virtual local area network (VLAN) tags into the data packets, the VLAN tags being used in allocating priorities to the data packets; and
establishing priorities of the VLAN tags such that a highest priority is allocated to isochronous packets from among the data packets.

2. The method as claimed in claim 1, wherein the legacy Ethernet device supports a protocol for processing packets based on priorities of the packets.

3. The method as claimed in claim 2, wherein the protocol for processing packets is IEEE (Institute of Electrical and Electronics Engineers) 802.1p/Q and/or 802.11e.

4. The method as claimed in claim 1, further comprising the steps of:
a) inputting a data packet from the legacy Ethernet device to a second Residential Ethernet switch;
b) performing a first parsing operation with respect to the input data packet to determine whether the input data packet includes a VLAN tag;
c) performing a second parsing operation with respect to the input data packet to determine whether the input data packet is an isochronous packet, when it is determined that the input data packet includes a VLAN tag; and
d) processing the input data packet as asynchronous data when the input data packet is not an isochronous packet, and processing the input data packet as isochronous data when the input data packet is an isochronous packet.

5. The method as claimed in claim 4, further comprising a step of: processing the input data packet as asynchronous data when it is determined hat the input data packet does not include a VLAN tag.

6. The method as claimed claim 1, wherein, when the legacy Ethernet device receives a packet having a high priority through a port connected to a different legacy Ethernet device, the legacy Ethernet device processes the received packet after lowering the priority of the received packet by a predetermined amount.

7. The method as claimed in claim 6, wherein the first Residential Ethernet switch performs a control operation such that a highest priority is not allocated to an asynchronous packet.

8. The method as claimed in claim 6, wherein the legacy Ethernet device restores an original priority of the packet having a priority lowered by the predetermined amount when outputting the packet.

9. The method as claimed in claim 1, wherein, in the step of establishing priorities of the VLAN tags a priority field of the VLAN tag is established to have a first predetermined value, and a VLAN ID field of the VLAN tag is established to have a predetermined value.

10. The method as claimed in claim 1, wherein, in the step of establishing priorities of the VLAN tags, a VLAN ID field of the VLAN tag is established to have a predetermined value.

11. The method as claimed in claim 1, wherein, in the step of establishing priorities of the VLAN tags, a predetermined field of the VLAN tag is assigned as a flag area for allocating a priority to the isochronous packet, and the assigned field is activated.

12. A computer-program product containing code executable on a computer for ensuring QoS (Quality of Service) of isochronous data in a Residential Ethernet system including a legacy Ethernet device, a first Residential Ethernet switch, in which the first Residential Ethernet switch transmits data packets to the legacy Ethernet device, the code providing instruction to the computer for executing a process comprising the steps of:
inserting, by the first Residential Ethernet switch, virtual local area network (VLAN) tags into the data packets, the VLAN tags being used in allocating priorities to the data packets; and
establishing priorities of the VLAN tags such that a highest priority is allocated to isochronous packets from among the data packets.

13. The computer-program product as claimed in claim 12, wherein the legacy Ethernet device supports a protocol for processing packets based on priorities of the packets.

14. The computer-program product as claimed in claim 12, wherein the protocol for processing packets is IEEE (Institute of Electrical and Electronics Engineers) 802.1p/Q and/or 802.11e.

15. The computer-program product as claimed in claim 12, wherein the code providing instruction to the computer for executing a process comprising the steps of:
a) inputting a data packet from the legacy Ethernet device to a second Residential Ethernet switch;
b) performing a first parsing operation with respect to the input data packet to determine whether the input data packet includes a VLAN tag;
c) performing a second parsing operation with respect to the input data packet to determine whether the input data packet is an isochronous packet, when it is determined that the input data packet includes a VLAN tag; and
d) processing the input data packet as asynchronous data when the input data packet is not an isochronous packet, and processing the input data packet as isochronous data when the input data packet is an isochronous packet.

16. The computer-program product as claimed in claim 15, wherein the code providing instruction to the computer for executing a process comprising the steps of:
processing the input data packet as asynchronous data when it is determined hat the input data packet does not include a VLAN tag.

17. The computer-program product as claimed claim 12, wherein, when the legacy Ethernet device receives a packet having a high priority through a port connected to a different legacy Ethernet device, the legacy Ethernet device processes the received packet after lowering the priority of the received packet by a predetermined amount.

18. The code providing instruction to the computer for executing a process comprising the steps of as claimed in claim 17, wherein the first Residential Ethernet switch performs a control operation such that a highest priority is not allocated to an asynchronous packet.

19. The computer-program product as claimed in claim 17, wherein the legacy Ethernet device restores an original priority of the packet having a priority lowered by the predetermined amount when outputting the packet.

20. The computer-program product as claimed in claim 12, wherein, in the step of establishing priorities of the VLAN tags a priority field of the VLAN tag is established to have a first predetermined value, and a VLAN ID field of the VLAN tag is established to have a predetermined value.

21. The computer-program product as claimed in claim 12, wherein, in the step of establishing priorities of the VLAN tags, a VLAN ID field of the VLAN tag is established to have a predetermined value.

22. The computer-program product as claimed in claim 12, wherein, in the step of establishing priorities of the VLAN tags, a predetermined field of the VLAN tag is assigned as a flag area for allocating a priority to the isochronous packet, and the assigned field is activated.

23. An apparatus for ensuring QoS (Quality of Service) of isochronous data in a Residential Ethernet system including a legacy Ethernet device, a first Residential Ethernet switch, in which the first Residential Ethernet switch transmits data packets to the legacy Ethernet device, the apparatus comprising:
a processor in communication with a memory located on the first Residential Ethernet switch, the processor executing code for:
inserting virtual local area network (VLAN) tags into the data packets, the VLAN tags used in allocating priorities to the data packets; and
establishing priorities of the VLAN tags such that a highest priority is allocated to isochronous packets from among the data packets.

24. The apparatus as claimed in claim 23, the processor further executing code for executing the step of:
processing the input data packet as asynchronous data when it is determined that the input data packet does not include a VLAN tag.

25. The apparatus as claimed in claim 23, wherein the first Residential Ethernet switch performs a control operation such that a highest priority is not allocated to an asynchronous packet.

26. The apparatus as claimed in claim 23, wherein, in the step of establishing priorities of the VLAN tags a priority field of the VLAN tag is established to have a first predetermined value, and a VLAN ID field of the VLAN tag is established to have a predetermined value.

27. The apparatus as claimed in claim 23, wherein, in the step of establishing priorities of the VLAN tags, a VLAN ID field of the VLAN tag is established to have a predetermined value.

28. The apparatus as claimed in claim 23, wherein, in the step of establishing priorities of the VLAN tags, a predetermined field of the VLAN tag is assigned as a flag area for allocating a priority to the isochronous packet, and the assigned field is activated.
